(19) United States
(12) Patent Application Publication
(10) Pub. No.: US 2002/0160730 A1
(43) Pub. Date: Oct. 31, 2002

(54) Frequency synthesizer and method of low-noise frequency synthesis

(76) Inventors: Franck Nozahic, Douvres La Delivrande (FR); Fabrice Jovenin, Caen (FR)

Correspondence Address: Corporate Patent Counsel, U.S. Philips Corporation, 580 White Plains Road, Tarrytown, NY, 10591, US

(21) Appl. No.: 09/965,458

(22) Filed: Sep. 27, 2001

(30) Foreign Application Priority Data
Sep. 29, 2000 (FR) 0012459

(51) Int. Cl. H04B 1/04

(52) U.S. Cl. 455/118

(57) ABSTRACT

A frequency synthesizer including a phase-locked loop (10), which phase-locked loop (10) comprises:

a frequency divider (14) having integral dividing ratios, connected between a voltage-controlled oscillator VCO (12) and a phase-frequency comparator PFD (16),

a sigma-delta modulator (30), connected to the frequency divider (14) for commuting the dividing ratio of the frequency divider between a series of at least two integral values, so as to obtain a resulting mean dividing ratio of fractional component, the modulator having at least a digital input (34, 50) suitable for receiving an adjusting instruction of the fractional component.

In accordance with the invention, the frequency synthesizer further includes:

means for fixing the value of the least significant bit of the adjusting instruction to 1.

The present invention relates to a frequency synthesizer and a method of low-noise frequency synthesis.

The invention more particularly relates to a frequency synthesizer whose output frequency can be adjusted by integral or fractional values.

Such a frequency synthesizer may be used in various types of radio circuits and, more particularly, in receiving and/or transmitting stages of these circuits. By way of example the frequency synthesizer according to the invention may be used in wireless telephony equipment such as portable telephones.

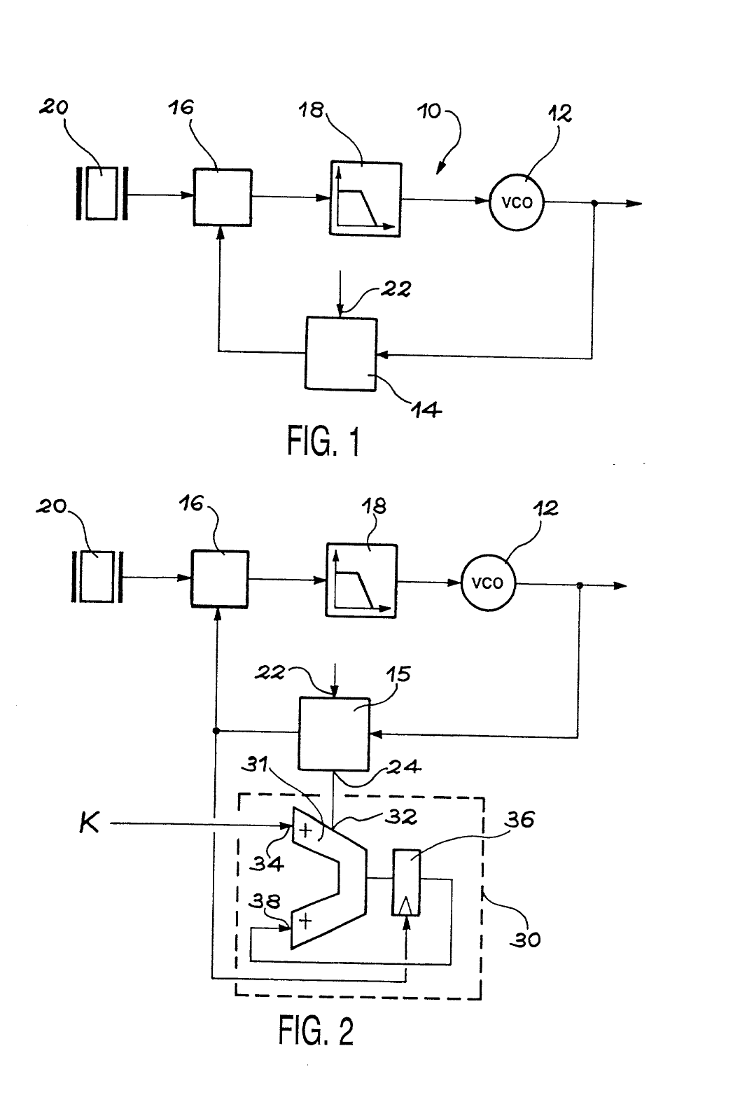

The appended FIGS. 1 and 2 illustrate an integral-value adjustable frequency synthesizer and a fractional-value adjustable frequency synthesizer. A fractional-value adjustable frequency synthesizer is understood to be a frequency synthesizer whose frequency can be adjusted by integral or non-integral multiples of a reference frequency. Such devices are known per se and illustrated, for example, by the documents (1), (2) and (3), whose complete references are stated at the end of the description.

FIG. 1 indicates the basic structure of a frequency synthesizer, which is constructed around a phase-locked loop 10. The phase-locked loop comprises, in essence, a voltage-controlled oscillator 12, a frequency divider 14, a phase-frequency comparator 16 and a low-pass filter 18.

The voltage-controlled oscillator 12, referred to as <<VCO oscillator>> in the following of the text, delivers an output signal whose frequency cannot be increased or reduced as a function of a control voltage applied to its input. This control voltage is produced by the phase-frequency comparator 16, which is connected to the input of the VCO oscillator 12 via the low-pass filter 18.

The phase-frequency comparator 16 compares the frequency (or phase) of a signal delivered by the frequency divider 14 and the frequency of a reference signal delivered in the example of the Figure by a quartz device 20. When the frequency of the signal delivered by the frequency divider is lower than that of the reference signal, the phase-frequency comparator produces a voltage instructing the frequency of the VCO oscillator 12 to be increased. Conversely, the frequency of the VCO oscillator is reduced when the frequency of the signal delivered by the frequency divider is higher than that of the reference signal.

The frequency divider 14 is a device constructed around a certain number of flip-flops and can thus divide the frequency of the signal of the VCO oscillator 12 only by integral values. The dividing ratio, which is adjustable by integral values, is an integer referred to as N. An adjusting input, indicated by an arrow 22, enables to fix the value N.

The frequency of the VCO oscillator, referred to as F_{VCO} is thus such that:

F_{VCO}=N*F_{ref}, where F_{REF} is the frequency of the reference signal delivered by the quartz device 20.

It is observed that a modification by unity of the value of the dividing ratio N (integral) provokes a variation equal to F_{ref} of the frequency of the VCO oscillator. Accordingly, it is impossible to adjust the frequency of the VCO oscillator 12 with a resolution higher than F_{ref}. In the case where the frequency of the reference signal is relatively high, this resolution may turn out to be insufficient.

A much finer adjustment of the frequency of the output signal of the loop 10, that is to say, of the frequency of the signal delivered by the VCO oscillator 12, may be obtained with a frequency synthesizer in accordance with FIG. 2.

The frequency synthesizer shown in FIG. 2 comprises a phase-locked loop 10 which includes the same elements as those of loop 10 of FIG. 1.

The frequency divider 14, on the other hand, has not only an adjusting input 22 for fixing the value N of the dividing ratio, but also a commutation input 24 for commutating the dividing ratio between two or more consecutive values around the value N. In the example of FIG. 2, the commutation input 24 of the frequency divider 14 enables to commute the dividing ratio between two values, which are N and N+1.

The commutation input 24 is connected to a sigma-delta modulator 30 and, to be more precise, to an overflow-carry terminal 32 of this modulator.

The sigma-delta modulator 30 which, in the example of the Figure, is a first-order digital modulator with a word adder 31, has a first digital input 34 for an adjusting instruction referred to as K. The adjusting instruction is added to a digital value delivered by a shift register 36 of the modulator. The register 36 is clocked by the output signal of the frequency divider 14, and receives the output of the word adder 31. It is connected to a second digital input 38 of the adder. When the sum of the adjusting instruction and of the output of the register 36 is lower than a digital capacity of the adder 31, the overflow-carry adopts the logic 0 value, for example. On the other hand, when the sum is higher than the capacity of the adder 31, the overflow-carry adopts the complementary logic 1 value in that case.

The frequency divider 14 is arranged for performing a frequency division with a first dividing ratio when its commutation input 24 receives the first logic state and for performing a division with a second dividing ratio which is different from +/−1, when the input 24 receives the second commutation state.

In the example described, the dividing ratio is N for a logic 1 state and N+1 for a logic 0 state.

Although at any instant the dividing ratio of the frequency divider is an integer, the repeated commutation of the ratio between N and N+1 enables to obtain a resulting mean dividing ratio comprised between these two values, that is to say, a non-integral ratio.

In a more precise way, one has:

$$Fvco = \frac{1}{{T}_{N} + {T}_{N + 1}} [ {T}_{N} * N * {F}_{ref} + {T}_{N + 1} * ( N + 1 ) * {F}_{ref} ]$$

$$Fvco = [ N + \frac{{T}_{N + 1}}{{T}_{N} + {T}_{N + 1}} ] * {F}_{ref}$$

that is,

In these expressions, T_{N} and T_{N+1}, are the periods during which the dividing ratio is equal to N and N+1, respectively.

Considering that the adjusting instruction K applied to the first input 34 of the sigma-delta modulator is coded in L bits, and that the maximum capacity of the adder is 2^{L}−1, a fractional part of the dividing ratio equal to K/2^{L} can be defined. One has:

$$Fvco = [ N + \frac{K}{{2}^{L}} ] * {F}_{ref}$$

For low values of the adjusting instruction (K≡0) the output frequency is close to F_{ref}*(N+) and for high values of the adjusting instruction (K≡2^{L}) the output frequency is close to F_{ref}*(N+1).

Accordingly, it is possible to continuously adjust the frequency of the phase-locked loop between two values fixed by the choice of the dividing ratio N applied to the adjusting input 22 of the frequency divider 14 and by the choice of the adjusting instruction K applied to the sigma-delta modulator.

The spectral analysis of the output of a frequency synthesizer using a phase-locked loop in accordance with FIG. 2 shows a distribution of noise components around a central line that corresponds to the frequency F_{VCO}. The noise results from the contribution of the various elements of the phase-locked loop and from the sigma-delta modulator.

As suggested by the document (3), already mentioned, it is possible to replace the sigma-delta modulator having one stage as represented in FIG. 2 by a sigma-delta modulator having various cascaded stages and, in particular, by a sigma-delta modulator having two stages. A sigma-delta modulator having two stages (of the second-order) indeed permits a better shaping of the frequency distribution of the noise by moving at least part of the noise to high frequencies. This phenomenon, accentuated by the multiplication of the stages, is referred to as “noise shaping”.

The inventors have actually given another demonstration of the noise in the spectral response of the frequency generator, which results in parasitic secondary lines. These secondary lines particularly appear for certain values of the adjusting instruction K.

The inventors have in effect established that the repetition of the logic values applied to the commutation input of the frequency divider are originally parasitic lines. The regular repetition of the logic values according to short patterns, for example, 110011001100 and so on, leads to a small number of parasitic lines. The amplitude of these lines, however, is important. This phenomenon takes place when the value of the adjusting instruction K is even.

When, on the other hand, the value of the adjusting instruction K is odd, the repetition of the patterns certainly continues to be regular, but the patterns become very long. The energy of the noise is then distributed over a large number of parasitic lines having low amplitude, which resemble a continuum. The amplitude of the lines taken individually is very low, however, so that they disappear in the noise of the other elements of the frequency synthesizer.

In a more precise way, the frequency value of the spurious frequencies may be given by the following relationship:

$${F}_{spur} = \frac{{F}_{ref} \cdot {2}^{M}}{{2}^{( 0 - 1 )} * {2}^{L}}$$

In this expression Fₛₚᵤᵣ indicates the frequency with which the parasitic lines recur and M indicates the number of times it is possible to divide the number K coded in L bits by 2, and 0 indicates the order of the sigma-delta modulator.

It is an object of the invention to propose an improved frequency synthesizer, whose frequency response spectrum obviously does not comprise parasitic lines that exceed a noise continuum. It is also an object to propose a method of synthesizing frequencies which permits of eliminating these parasitic lines.

To achieve these objects, it is more particularly an object of the invention to provide a frequency synthesizer with a phase-locked loop, which loop comprises:

a frequency divider, having integral dividing ratios, connected between a voltage-controlled oscillator (VCO) and a phase-frequency comparator (PFD),

a sigma-delta modulator connected to the frequency divider for switching the dividing ratio of the frequency divider between a series of at least two integral values, so as to obtain a resulting mean dividing ratio with a fractional component, the modulator having a digital input for an adjusting instruction of the fractional component.

According to the invention, the frequency synthesizer further includes:

means for setting the value of the least significant bit of the adjusting instruction to 1.

Setting the value of the least significant bit of the adjusting instruction to 1 narrows down to rendering it odd. This permits to distribute the noise energy over a frequency continuum. For each of these frequencies, taken individually, the noise amplitude is consequently very low. Outside the central oscillation frequency, no parasitic line then appears on the frequency response spectrum.

According to a particular embodiment of the frequency synthesizer, this frequency synthesizer may comprise an input register of a control value of the fractional component and also means for replacing the least significant bit of the control value by the value 1 and for applying this value as an adjusting instruction to the modulator.

In that case, the least significant bit of the adjusting instruction is arbitrarily set to 1, whatever the value introduced in the input register. The replacement of the least significant bit might only take place if this least significant bit differs from 1 (that is to say, is equal to 0).

According to another possibility, the means for setting the value of the least significant bit to 1 may comprise means for adding a bit equal to 1 to the control value of the fractional component and thus for forming the adjusting instruction applied to the input of the sigma-delta modulator.

By way of example, when the frequency synthesizer comprises an input register of rank L−1, the means for adding a bit equal to 1 may comprise a rank-L instruction register and a locked flip-flop to set the least significant bit of the register of rank L to 1.

In that case, a first value coded in L−1 bits is replaced by a new value coded in L bits, whose least significant bit is equal to 1. The latter value is then used as an adjusting instruction.

Strictly speaking, the modification of the least significant bit calls forth a modification of the instruction value K desired by the user and thus a modification of the oscillation frequency of the phase-locked loop. However, the error of the instruction value effectively applied to the sigma-delta modulator remains limited to ½^{L} and leads to an imperceptible change of frequency. By way of illustration, for a coding in 24 bits (L=24), the error is ½²⁴.(<10⁻⁷).

The frequency synthesizer according to the invention may comprise a sigma-delta modulator which has a single stage or a modulator which has several cascaded stages.

It emerges from the preceding description that, for obtaining a mean dividing ratio that has a fractional component, the dividing ratio of the frequency divider is commuted with integral dividing ratios, between two or various, generally consecutive, integral values. For a mean dividing ratio of N+k, where k represents the fractional component and N the integral component, a commutation may be made, for example, between N and N+1.

It has been established that when N+k is close to N r N+1, that is to say, when the fractional component k is close to 0 or 1, one of the values of the integral dividing ratio (N or N+1) becomes very predominant relative to the other. By way of illustration, when k is close to 0, that is to say, when N+k≡N. the dividing ratio N is frequent in the commutation, whereas the factor N+1 is rare.

The inventors have proved the fact that the high repetition of a same integral dividing ratio at the cost of one or various other integral dividing ratios which have been made rare, also leads to a noise that is manifested by parasitic lines in the spectral response of the frequency synthesizer.

To avoid this noise it is possible, according to a particular aspect of the invention, to equip the frequency synthesizer with at least a frequency divider that has a fixed fractional dividing ratio, which divider is connected between the voltage-controlled oscillator VCO and the frequency divider that has integral dividing ratios. The frequency synthesizer is in that case also equipped with means for activating the frequency divider which has fractional dividing ratios when the fractional component (k) of the mean dividing ratio lies in one or various ranges of predetermined values.

More precisely, the frequency divider having the fractional dividing ratios may be activated when the fractional component is close to 0 or 1 and deactivated in the opposite case. For example, the value ranges of the fractional component k, such as 0<k<0.25 and such as 0.75<k<1, may correspond to activation ranges of the frequency divider having fractional dividing ratios.

The activation of the frequency divider having fractional dividing ratios advantageously permits to modify the fractional component of the mean dividing ratio which is to be obtained by the frequency divider having integral dividing ratios, which divider is associated to the sigma-delta modulator.

To revert to the example given earlier, when an additional division by 1.5 is made, this narrows down to adding 0.5 to the fractional component of the desired mean dividing ratio.

Thus by supposing that 0<k<0.25, we have:

N+k=N+0.5+k′.

In this expression the new fractional component k′ is such that

0.25≦k′≦0.75.

Similarly, by supposing that 0.75<k<1, we have:

N+k=N−1+0.5+k′,

where k′ is such that 0.25≦k′≦0.75.

In other words, k′, the new fractional component that is to be generated by the frequency divider having integral dividing ratios, which divider is associated to the sigma-delta modulator, authorizes a more balanced alternation between the dividing ratios, for example, N and N+1 and avoids parasitic lines.

The invention also relates to a method of synthesizing a phase lock by means of a frequency synthesizer, which synthesizer comprises:

a frequency divider having integral dividing ratios, connected between a voltage-controlled oscillator (VCO) and a phase-frequency comparator (PFD),

a sigma-delta modulator connected to a frequency divider for commuting the dividing ratio of the frequency divider between a series of at least two consecutive integral values, so as to obtain a resulting mean dividing ratio with a fractional component, the modulator having a digital input for an adjusting instruction of the fractional component.

In accordance with the method, an adjusting instruction is formed for the sigma-delta modulator, by the modification of a control input value. The input value is modified so as to make it odd.

When the frequency synthesizer is equipped with a frequency divider having a fixed fractional dividing ratio, as indicated previously, said frequency divider having a fractional dividing ratio is activated when the fractional component (k) of the mean dividing ratio is contained in at least a given value range, and in corresponding manner the adjusting instruction of the fractional component of the sigma-delta modulator is modified to keep a rough dividing ratio unchanged which is produced by the frequency divider with a fractional dividing ratio, which divider is associated to the frequency divider having integral dividing ratios. This aspect of the invention will be described in more detail in the following of the text.

The invention also relates to a frequency converter comprising a mixer with a first input, which can be connected to a signal source which delivers a signal with a frequency to be converted. The converter further includes a signal source which has a reference frequency, connected to a second input. In accordance with the invention, the signal source which has a reference frequency may include a frequency synthesizer as described above. Such a frequency converter may notably be used in a portable telephone.

Finally, the invention relates to a frequency synthesizer including a phase-locked loop, which frequency synthesizer comprises:

a frequency divider having integral dividing ratios, connected between a voltage-controlled oscillator VCO and a phase-frequency comparator PFD,

a sigma-delta modulator connected to the frequency divider for commuting the dividing ratio of the frequency divider between a series of at least two integral values, so as to obtain a resulting mean dividing ratio with a fractional component, the modulator having at least a digital input suitable for receiving an adjusting instruction for adjusting the fractional-component, and

at least a frequency divider having a fixed fractional dividing ratio, connected between the voltage-controlled oscillator VCO and the frequency divider having integral dividing ratios, and means for activating the fractional dividing ratio when the fractional component (k) of the mean dividing ratio is contained in at least a given value range.

Other characteristics and advantages of the invention pertain to the description that will follow, and have reference to the appended drawing Figures. This description is given in a purely illustrative and non-limitative capacity.

FIG. 1, already described, is a simplified basic circuit diagram of a known frequency synthesizer which has discrete frequency adjustment,

FIG. 2, already described, is a simplified basic circuit diagram of a known frequency synthesizer which has continuous frequency adjustment,

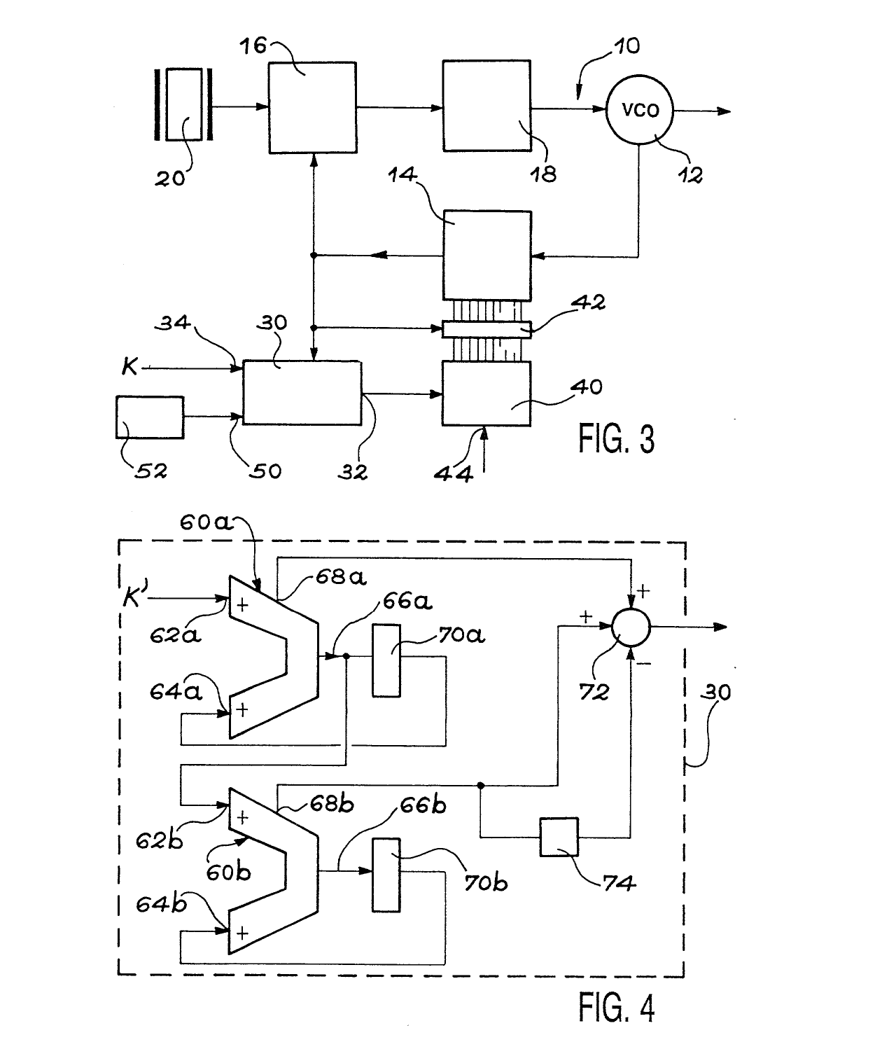

FIG. 3 is a simplified diagram of a frequency synthesizer in accordance with the invention,

FIG. 4 is a diagram illustrating a particular embodiment of a sigma-delta modulator for a frequency synthesizer as shown in FIG. 3,

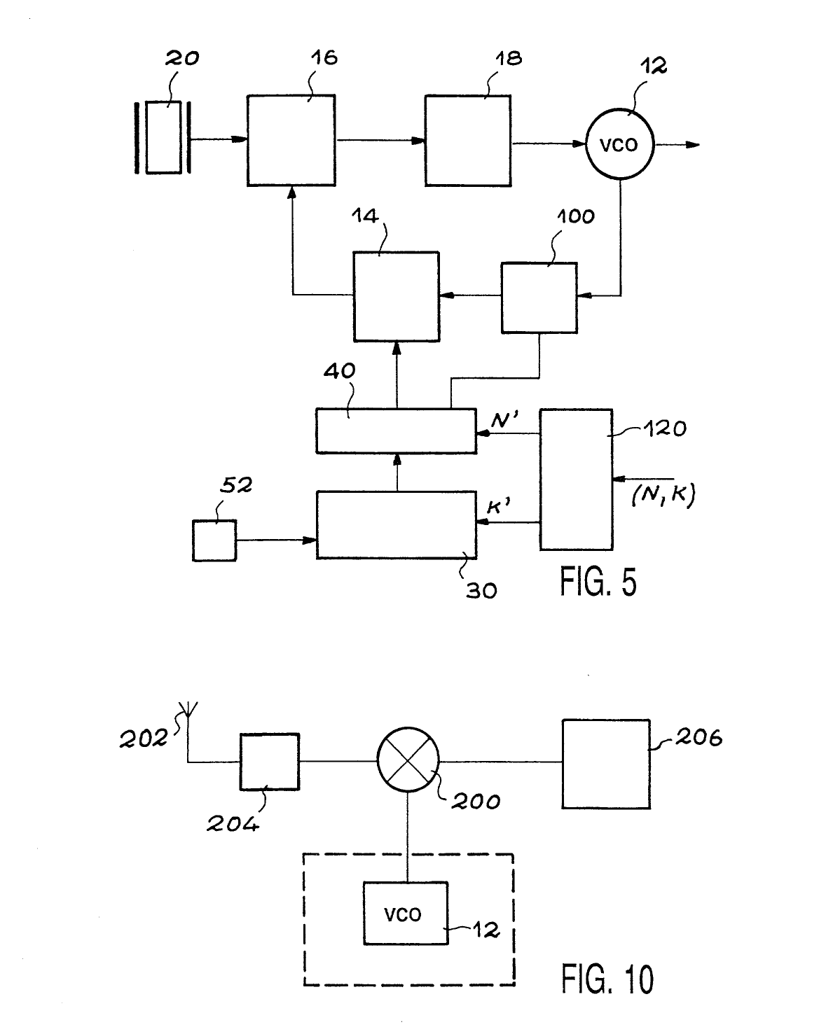

FIG. 5 is a simplified basic circuit diagram illustrating a perfected possibility of embodiment of a frequency synthesizer in accordance with the invention,

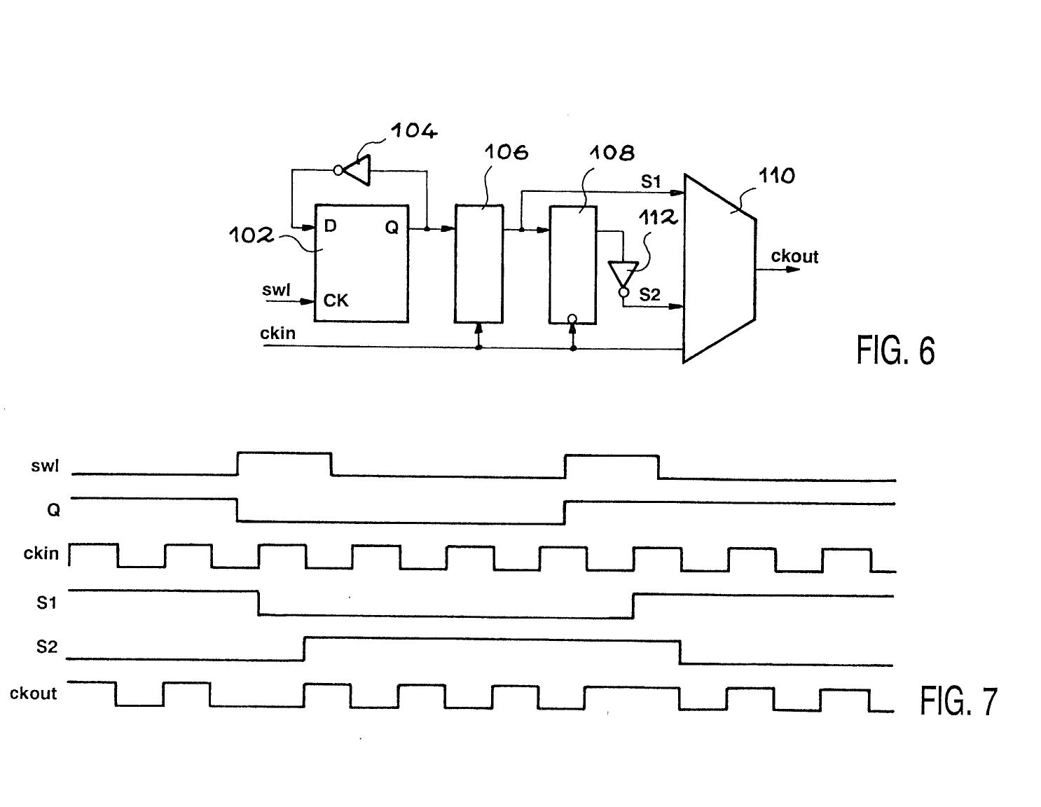

FIG. 6 is a diagrammatic representation of a frequency divider having a fixed fractional dividing ratio, used in the frequency synthesizer shown in FIG. 5,

FIG. 7 is a timing diagram illustrating the operation of the frequency divider which has a fixed fractional dividing ratio of FIG. 6,

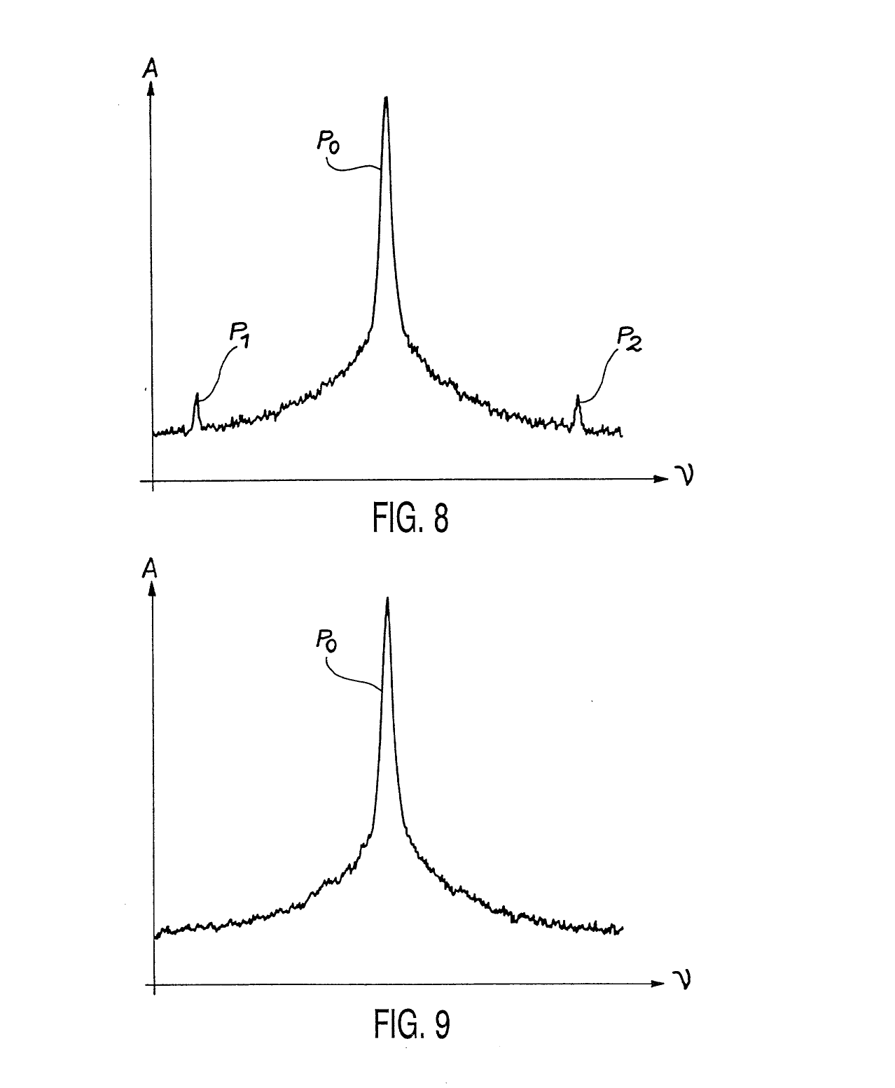

FIG. 8 is a diagram illustrating the spectral response of a frequency synthesizer in accordance with FIG. 2,

FIG. 9 is a diagram illustrating the spectral response of a frequency synthesizer designed in accordance with the invention, and

FIG. 10 is a diagrammatic representation of a frequency converter which uses a frequency synthesizer in accordance with the invention.

The elements of FIGS. 3, 4 and 5 that are identical, similar or equivalent to corresponding elements of the preceding Figures, are referred to with like references and their detailed description is not again reverted to here.

FIG. 3 shows a frequency synthesizer constructed around a phase-locked loop 10, which phase-locked loop 10 comprises a voltage-controlled oscillator 12, a frequency divider 14, a phase-frequency comparator 16 and a low-pass filter 18.

The frequency divider 14 is a programmable divider capable of dividing the frequency of a signal applied thereto by an integral number. It is associated to a dividing ratio calculator 40 intended to control a dividing ratio denoted N as a function of a signal delivered by a sigma-delta modulator 30.

More precisely, the calculator 40 controlled by the sigma-delta modulator is capable of controlling a commutation of the dividing ratio between two or more integral consecutive values (or non-consecutive values) to obtain a mean dividing ratio with a fractional component.

Reference 42 simply indicates a synchronization register connected between the calculator 40 and the frequency divider 14. This register and also the sigma-delta modulator are clocked with the output signal of the frequency divider 14, which is applied to these elements. Reference 44 indicates an input of the calculator 40 provided for the selection of a channel by the user, that is to say, for the selection of the integral part of the desired dividing ratio.

It may be observed that the sigma-delta modulator has two inputs 34 and 50.

The first input 34 is totally comparable to the digital input of the sigma-delta modulator of FIG. 2. It is intended for the transmission of a control value K of the fractional component to the modulator. The first input is coded with a number of L−1 bits, equal, for example, to 22. The control value K may be entered by the user or, as the case may be, by another part of the tuning circuit (not shown).

The second input 50 of the modulator, coded with a single bit, is connected to a flip-flop 52 locked on to the logic 1 value. The second input and the locked on flip-flop 52 are shown in the figure for clarity, but are in fact integrated on the same chip as the sigma-delta modulator and are not accessible to the user.

The control value K applied to the first input 34 is combined with the 1 value available on the second input 50 to form a new adjusting instruction value k′. This new instruction value k′ is coded with L bits and is formed by the value 1 of input 50 which constitutes the least significant bit and the L−1 bits of the first input 34 which constitute the most significant bits.

The new instruction value k′, in effect used for the sigma-delta modulator, is thus of necessity an odd instruction value.

Other possibilities may be envisaged to form an odd adjusting instruction value k′. It is possible, for example, to substitute the value 1 for the value of the least significant bit of the control value K applied to the first input 34.

Output 32 of the sigma-delta modulator, connected to the calculator 40 is coded with two bits in the example shown. However, a coding with a single bit as in the example of FIG. 2 is also possible.

FIG. 4 described hereinafter indicates a possible embodiment of the sigma-delta modulator 30 of FIG. 3 and permits to better understand the two-bit coding of output 32.

The sigma-delta modulator of FIG. 4 comprises two cascaded stages, constructed each around a word adder. A first word adder 60a has a first input 62a to which the adjusting instruction k′ is applied which, in accordance with the invention, has been made odd.

The output 66a of the first word adder 60a is connected to its second input 64a via a timing register 70a. The timing register 70a may be controlled, for example, by the divided frequency signal delivered by the frequency divider. Then, with each pulse, the sum obtained previously on output 66a is sent back to the second input.

When the sum is lower than the capacity of the word adder, the word adder delivers on its overflow terminal 68a a carry, of which the logic value is 0. On the other hand, when the sum is higher than the capacity of a logic value (carry) 1 is delivered. In that case, only the rest of the addition that does not exceed the capacity of the word adder is delivered on output 66a.

Finally, the overflow terminal 68a delivers a logic value coded with a single bit, which may occupy the 0 or 1 state.

The output 66a is also connected to the first input 62b of the word adder 60b of the second stage. Similarly, the output 66b of this adder is connected to its second input 64b via a timing register 70b.

The word adder 60b of the second stage also has an overflow terminal 68b, whose logic output, coded with two bits, may occupy the 0 and 1 states.

An adder/subtracter 72, which has three inputs, receives on the positive input the logic values available on the overflow terminals of the two word adders 60a and 60b. It also receives, on the negative input, the carry of the overflow terminal of the word adder 60b of the second stage, via a delay flip-flop 74.

The output 76 of the adder/subtracter is directed to the calculator 40 for the calculation of the dividing ratio referred to in relation to FIG. 3.

The Table I hereinafter gives as an indication the value (decimal) of the output of the adder/subtracter 72 as a function of the values of the inputs, and indicates the corresponding dividing ratio imposed on divider 14.

TABLE I

| Adder 60a | Adder 60b | Delay flip-flop 74 | | |
|---|---|---|---|---|
| (logic) | (logic) | (logic) | Output 72 | Division by |
| 0 | 0 | 1 | −1 | N − 1 |
| 0 | 1 | 0 | 1 | N |
| 1 | 0 | 1 | 0 | N + 1 |
| 1 | 1 | 0 | 2 | N + 2 |

The successive division by the above dividing ratios, whose sequence is dictated by the adjusting instruction k′, permits to obtain a mean fractional dividing ratio comprised between N and N+1.

(May the formula be given for this?)

The FIGS. 5 and 6 examined hereinafter permit to illustrate in terms of noise the improvement obtained thanks to the invention.

As mentioned earlier, the inventors have established that the parasitic lines of the response spectrum appear with a recurrence frequency Fₛₚᵤᵣ, so that:

Fₛₚᵤᵣ=F_{ref}/(R*(2^{L}/2^{m})).

(Verify the cohesion with the formula given on page 4).

In this expression, R is the order of the sigma-delta modulator, that is to say, the number of stages of the modulator. L is the number of bits in which the adjusting instruction is coded and M the number of times the adjusting instruction can be divided by 2.

By way of example, for a sigma-delta modulation factor of 0.5, that is, for an instruction K of 2²² (that is to say, without rendering the factor odd in accordance with the invention), one would have M=2²². Thus, with a reference frequency F_{ref} of 13 MHz, one would obtain a low number of parasitic lines which are repeated with a recurrence of 6.25 MHz. These scarce lines (every 6.25 MHz) have, however, a considerable amplitude, which corresponds to the energy of the noise.

FIG. 5 described hereinafter indicates another possibility of implementing the invention. A large number of elements of FIG. 5 are identical with those of the Figures described earlier and are referred to by like reference characters. For these elements, reference may thus be made to the preceding description.

Different from the synthesizer shown in FIG. 3, the frequency synthesizer shown in FIG. 5 is equipped with an additional frequency divider 100 connected between the voltage-controlled oscillator 12 (VCO) and the frequency divider 14 which has integral dividing ratios. The additional frequency divider 100 is a frequency divider which has a fractional, but fixed, dividing ratio. In the example described, the fixed dividing ratio is 1.5. This means that the additional divider may either divide the frequency of the signal it receives by 1.5 when it is activated, or let the signal pass unchanged when it is not activated. In that case, the division is as it were a division by 1. It should be pointed out that the divider 100 may be replaced by a divider that has a different fractional ratio or by a series of two or more fractional dividers, connected after each other.

The fractional component k of the mean dividing ratio produced by the divider 14 which has integral dividing ratios, associated to the sigma-delta modulator, is linked with the adjusting instruction K by the following relation:

K=K/2^{L}, that is, K=2^{L}*k.

It will be recollected that L is the number of bits on which the instruction K is coded.

A circuit stage or a calculator (not shown) is provided to establish the integral component N and the fractional component k of the mean dividing ratio as a function of the desired oscillation frequency. The values N and k (or K) are transmitted to a calculator 120 provided for verifying whether k is not too close to the value 0 or 1, that is to say, if K is not too close to the value 0 or 2^{L}. In the example shown is considered that k is not too close to 0 or 1 when the following relation is verified:

0.25≦k≦0.75.

The calculator 120 is connected to the sigma-delta modulator 30 and to the dividing ratio calculator 40, already mentioned with respect to FIG. 3, to transmit thereto the new values N′ and k′ (or k′).

Table II hereinafter permits to recapitulate the rules of establishing the values N′ and k′ as a function of the value of k.

TABLE II

| Value of k | Value of k′ | Value of N′ | Value of K′ |
|---|---|---|---|
| 0 < k < 0.25 | k′ = k + 0.5 | N′ = N − 0.5 | K′ = 2L * k′ |
| 0.25 ≦ k ≦ 0.75 | k′ = k | N′ = N | K′ = 2L * k′ |
| 0.75 < k < 1 | k′ = k − 0.5 | N′ = N + 0.5 | K′ = 2L * k′ |

It may be observed in the Table that N′ is no longer of necessity an integral value, whereas N was. It must be pointed out in this respect that via a binary coding set it is possible to reduce the expression of N′ to a coded digital value.

The dividing ratio calculator 40 is connected to the divider 14 which has integral dividing ratios in order to impose a succession of integral dividing ratios during the signal received by the sigma-delta converter in a manner described previously.

As the sigma-delta converter receives the new adjusting instruction, it permits to control a sequence of integral dividing ratios of the divider 14 in which no excessive repetition takes place of an (integral) dividing ratio.

The integral dividing ratios alternate, for example, between values P and P+1, or also, in the example described, between values P−1, P, P+1 and P+2. In this respect Table I may be referred to by analogy.

The dividing ratios P−1, P, P+1 and P+2 are established in the calculator 40 as a function of the output of the sigma-delta modulator and as a function of the integral part of N′, that is to say, as a function of N.

The dividing ratio calculator 40 also controls the activation or not of the divider 100 having the fractional dividing ratio. In a particular case where N is a digital value (coded, for example, with 6 bits), the least significant bit may be used for the activation (or not) of the frequency divider which has a fractional dividing ratio, whereas the other bits (the most significant bits) may be used for determining the value of P mentioned above.

The Table III hereinafter, which should be read in association with the Table II, indicates, depending on the value of k, the value of P as a function of N and the activation state of divider 100, which has a fractional dividing ratio.

TABLE III

| | | | Activation of the divider |
|---|---|---|---|
| Value of k | Value of N′ | Value of P | 100 |
| 0 < k < 0.25 | N − 0.5 | P = N − 1 | Yes (divide-by-1.5 divider) |
| 0.25 ≦ k ≦ 0.75 | N | P = N | No (divide-by-1 divider) |
| 0.75 < k < 1 | N + 0.5 | P = N | Yes (divide-by-1.5 divider) |

Thanks to the activation of the divider 100, which has a fractional dividing ratio, it is possible, without changing the rough dividing ratio obtained by the two dividers 14 and 100, that is to say, without changing the output frequency of the frequency synthesizer, to perfect the elimination of parasitic noise lines in its spectral response.

FIG. 6 proposes a particular possibility of realization of a divider which has a fractional factor. In this case a divide-by-1.5 divider is concerned, as referred to previously.

The divider of FIG. 6 comprises a flip-flop D102 of known type with an input D and an output Q. A second input receives a synchronization signal denoted sw1. The output Q of the flip-flop 102 is connected, on the one hand, to the input D via an inverter 104, and on the other hand, to the input of a first latch gate 106.

The output of the first latch gate 106 is connected, on the one hand, to the input of a second latch gate 108 and, on the other hand, to a first input S1 of a multiplexer 110. The output of the second latch gate 108 is connected to a second input S2 of the multiplexer 110 via an inverter 112. The latch gates 106 and 108, similarly to the multiplexer 110, are timed with an input signal ckin which is in this case the signal to be divided.

The divided signal, denoted ckout, available on the output 114 of the multiplexer 110, corresponds to the input signal in which certain transition edges between a high state and a low state are eliminated.

The operation of the divider of FIG. 6 is described by the timing diagram of FIG. 7 which, on the same time-dependent basis, indicates the state of the inputs and outputs of the components of the divider of FIG. 6. The timing diagram indicates, more particularly, the synchronization signal sw1, the output signal Q of the flip-flop D102, the input signal ckin to be divided, the signal available on the inputs S1 and S2 of the multiplexer and the divided output signal ckout. By comparing the signals ckin and ckout, one will notice that transition edges are eliminated step by step, notably when the inputs S1 and S2 are in the same logic state. The elimination of these edges corresponds to the division of the frequency.

FIG. 8 is a diagram which represents the amplitude A of the spectral response of a synthesizer which is not used by the invention, as a function of the frequency v plotted at the abscissa. FIG. 8, whose scale is arbitrary, permits to distinguish parasitic lines P₁ and P₂ on either one of the two sides of the main line P₀, and corresponding to the oscillation frequency of the loop.

On the other hand, by making the instruction k′ odd in the way described previously, the repetition frequency of the “parasitic” line drops to 0.77 Hz. They are thus numerous lines and they are very close together and the noise energy is distributed. The amplitude of the parasitic lines is thus very low, so that these lines are no longer perceptible.

This result appears in FIG. 9, which indicates, in a manner comparable to FIG. 8, the spectral response of a frequency synthesizer in accordance with the invention. One further observes only a single line P₀ which corresponds to the oscillation frequency of the loop.

FIG. 10 shows an application of a frequency synthesizer in accordance with the invention to the realization of a frequency converter and, more precisely, to a frequency converter in a signal transceiver.

The converter comprises a mixer to which is connected, on the one hand, a source of a signal to be converted, for example, an antenna 202 associated to a filter 204, and, on the other hand, a processing unit 206. The processing unit 206 receives the signal whose frequency is converted. This is, for example, a processing unit of a portable telephone.

The mixer 200 also receives a reference frequency signal which, in the example described, comes from a VCO oscillator 12 of a frequency synthesizer 1 in accordance with the invention.

### Cited Documents

(1) EP-B-0 661 816

(2) EP-A-0 563 400

(3) “Fractional-N P11 using delta-sigma modulation” by Thomas Stichelbout Aalborg University, Aug. 5, 1997, pp. 1 to 21.

1. A frequency synthesizer including a phase-locked loop (10), which phase-locked loop (10) comprises:
a frequency divider (14) having integral dividing ratios, connected between a voltage-controlled oscillator VCO (12) and a phase-frequency comparator PFD (16),
a sigma-delta modulator (30), connected to the frequency divider (14) for commuting the dividing ratio of the frequency divider between a series of at least two integral values, so as to obtain a resulting mean dividing ratio with a fractional component, the modulator having at least a digital input (34, 50) suitable for receiving an adjusting instruction of the fractional component, characterized in that the frequency synthesizer further includes:
means for fixing the value of the least significant bit of the adjusting instruction to 1.

2. A synthesizer as claimed in claim 1, having an input (34) for a control value (K) of the fractional component, and in which the means for fixing the value of the least significant bit to 1 comprise means (52) for adding one bit equal to 1 to the control value (K) of the fractional component and thus for forming the adjusting instruction (k′) applied to the sigma-delta modulator.

3. A synthesizer as claimed in claim 2, comprising an input register of rank L−1, where L is an integer, and in which the means for adding a bit equal to 1 comprise an instruction register of rank L, a locked flip-flop (52) for setting the least significant bit of the register of rank L to 1 and means for copying the control value in the instruction register of rank L as most significant bits.

4. A synthesizer as claimed in claim 1, comprising an input register which has a control value (K) of the fractional component, in which the means for setting the value of the least significant bit of the adjusting instruction to 1 comprise means for replacing the least significant bit of the control value by the value 1 and for applying this value to the modulator as an adjusting instruction.

5. A frequency synthesizer as claimed in claim 1, in which the sigma-delta modulator is a two-stage modulator.

6. A synthesizer as claimed in claim 1, further including at least a frequency divider (100) having a set fractional dividing ratio, the divider (100) being connected between the voltage-controlled oscillator VCO (12) and the frequency divider (14) having integral dividing ratios, and means (40, 102) for activating the frequency divider having a fractional dividing ratio when the fractional component (k) of the mean dividing ratio is contained in at least a given range of values, and for modifying in a corresponding manner the adjusting instruction of the fractional component of the sigma-delta modulator to keep a rough dividing ratio unchanged of the frequency divider having a fractional dividing ratio, the latter divider being associated to the frequency divider that has integral dividing ratios.

7. A synthesizer as claimed in claim 6, in which the value ranges of the fractional component k, such as 0<k<0.25 and 0.75<k<1, correspond to activation ranges of the frequency divider (100) which has a fractional dividing ratio.

8. A synthesizer as claimed in claim 7, in which the divider having fractional dividing ratios is a divide-by-1.5 divider.

9. A method of synthesizing frequency by means of a phase locking synthesizer, comprising:
a frequency divider (14) having integral dividing ratios, connected between a voltage-controlled oscillator VCO (12) and a phase-frequency comparator PFD (16),
a sigma-delta modulator (30), connected to the frequency divider for commuting the dividing ratio of the frequency divider between a series of at least two integral values so as to obtain a resulting mean dividing ratio that has a fractional component, the modulator having a digital input for an adjusting instruction of the fractional component, and according to which an adjusting instruction is formed for the sigma-delta modulator via a modification of a control input value, the input value being modified to make it an odd value.

10. A method as claimed in claim 9, in which a least significant bit of the control input value is modified to make it equal to 1.

11. A method as claimed in claim 9, in which a least significant bit, equal to 1, is added to the control input value to form the adjusting instruction.

12. A frequency synthesizing method as claimed in claim 9, by means of a frequency synthesizer which further includes at least a frequency divider (100) having a fixed fractional dividing ratio, connected between the voltage-controlled oscillator (12) and the frequency divider (14) having integral dividing ratios, in which method said frequency divider having fractional dividing ratios is activated when the fractional component (k) of the dividing ratio is contained in at least a given range of values and the adjusting instruction of the fractional component of the sigma-delta modulator is modified in corresponding manner to keep a rough dividing ratio unchanged of the frequency divider having a fractional dividing ratio, the latter divider being associated to the frequency divider that has integral dividing ratios.

13. A method as claimed in claim 12, in which said frequency divider having a fractional dividing ratio is activated when the fractional component k of the dividing ratio is such that 0<k<0.25 or 0.75<k<1, and said frequency divider having a fractional dividing ratio is deactivated when the fractional component k of the dividing ratio is such that 0.25≦k≦0.75.

14. A frequency converter comprising a mixer (200) which has a first input connected to a signal source which delivers a signal with a frequency to be converted, and comprising a signal source (1) which has a reference frequency connected to a second input of the mixer, characterized in that the signal source (1) which has a reference frequency comprises a frequency synthesizer as claimed in any one of the preceding claims.

15. A use of a frequency converter as claimed in claim 14 in a portable telephone.
